(19) United States
(12) Patent Application Publication
(10) Pub. No.: US 2021/0136587 A1
(43) Pub. Date: May 6, 2021

(54) DETECTING ROGUE-ACCESS-POINT ATTACKS

(71) Applicant: ARRIS Enterprises LLC, Suwanee, GA (US)

(72) Inventors: Wenge Ren, Sunnyvale, CA (US); Bowen Zhang, Sunnyvale, CA (US); Wei Sheng Hsu, San Jose, CA (US)

(73) Assignee: ARRIS Enterprises LLC, Suwanee, GA (US)

(21) Appl. No.: 17/088,139

(22) Filed: Nov. 3, 2020

Related U.S. Application Data
(60) Provisional application No. 62/930,509, filed on Nov. 4, 2019.

(51) Int. Cl. H04W 12/12; H04L 9/08; H04L 9/32; H04W 12/04; H04W 12/00

(52) U.S. Cl. CPC H04W 12/1202; H04L 9/0866; H04L 2209/80; H04W 12/0401; H04W 12/00512; H04L 9/32

(57) ABSTRACT

An electronic device (such as an access point) may receive a packet (or a frame) from a second electronic device, where the packet includes an encrypted unique identifier of the second electronic device. For example, the encrypted unique identifier may be included in a manufacturer-specific information element in a management packet. Then, the electronic device may decrypt the encrypted unique identifier using an encryption key or a secure hash function to obtain the unique identifier. Next, the electronic device may determine whether the second electronic device is an instance of an authorized access point in the WLAN based at least in part on the unique identifier. Note that the second electronic device may be an instance of an authorized access point when the unique identifier is associated with a manufacturer of the electronic device and/or the second electronic device.

### CROSS REFERENCE TO RELATED APPLICATIONS

This application claims priority under 35 U.S.C. 119(e) to: U.S. Provisional Application Ser. No. 62/930,509, “Detecting Rogue-Access-Point Attacks,” filed on Nov. 4, 2019, by Wenge Ren, et al., the contents of which are herein incorporated by reference.

### BACKGROUND

### Field

The described embodiments relate to techniques for detecting a rogue access point in a wireless local area network (WLAN).

### Related Art

Many electronic devices are capable of wirelessly communicating with other electronic devices. For example, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network.

In a WLAN based on an IEEE 802.11 standard, one or more electronic devices (which are sometimes referred to as stations, client devices or recipient electronic devices) discover, associate with and communicate with one or more access points.

However, sometimes an access point (which is henceforth referred to as a ‘rogue access point’) in a WLAN operates without authorization from a network administrator. Notably, a rogue access point operated by a malicious attacker may pretend to be a part of the WLAN in order to intentionally degrade the communication performance (and, thus, the user experience), to intercept information included in packets or frames, and/or to lure users into another WLAN. For example, a rogue access point may be added by a competitor. Alternatively, a smartphone user may configure their phone to operate as a hotspot, so that other client devices can share the WLAN. In the process, the WLAN bandwidth may be reduced. Indeed, such malicious activity may cause the WLAN to shut down. Consequently, the presence of a rogue access point in a WLAN can disrupt service and/or may pose a security threat.

### SUMMARY

A first group of described embodiments relates to an electronic device (such as an access point) that detects a rogue access point in a WLAN is described. This electronic device includes an interface circuit that wirelessly communicates with a second electronic device. During operation, the electronic device receives, at the interface circuit, a packet (or a frame, which is included in a packet) from the second electronic device, where the packet includes an encrypted unique identifier of the second electronic device. Then, the electronic device decrypts the encrypted unique identifier using an encryption key or a secure hash function to obtain the unique identifier. Next, the electronic device determines whether the second electronic device is an instance of an authorized access point in the WLAN based at least in part on the unique identifier.

Note that the packet may be a management packet. For example, the encrypted unique identifier may be included in a manufacturer-specific information element in the management packet.

Moreover, the unique identifier may be one of: a media access control (MAC) address of the second electronic device, a Serial Number of the second electronic device, an association identifier or AID of the second electronic device, channel information of the second electronic device, or a radio-frequency configuration of the second electronic device. In some embodiments, the second electronic device may be an instance of an authorized access point when the unique identifier is associated with a manufacturer of the electronic device and/or the second electronic device.

Furthermore, the encryption key or the secure hash function may be common to or shared by the electronic device and the second electronic device.

Additionally, prior to receiving the packet, the electronic device may have received: the encryption key, the secure hashing function, a unique identifier of the second electronic device, and/or the unique identifier of the electronic device from a controller.

In some embodiments, when the second electronic device is not the instance of the authorized access point, the electronic device performs a remedial action. For example, the electronic device may provide a message (such as an alert) to the controller and/or to one or more additional access points in the WLAN. Moreover, the electronic device may provide a second message (such as a warning) to a third electronic device that is associated with the second electronic device, or may de-authenticate the third electronic device from the WLAN, so that the association between the third electronic device and the second electronic device is discontinued. Furthermore, the electronic device may change a channel used by the electronic device in the WLAN and/or a service set identifier (SSID) of the electronic device. Additionally, the electronic device may prevent a third electronic device from associating with the second electronic device.

Moreover, the electronic device may determine a location of the second electronic device, and determining whether the second electronic device is the instance of an authorized access point may be based at least in part on the location.

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

A second group of described embodiments relates to an electronic device (such as an access point) that provides a unique identifier in a WLAN is described. This electronic device includes an interface circuit that wirelessly communicates with a second electronic device. During operation, the electronic device encrypts a unique identifier of the electronic device using an encryption key or a secure hash function to obtain an encrypted unique identifier. Then, the electronic device provides, from the interface circuit, a packet (or a frame, which is included in a packet) to the second electronic device, where the packet includes the encrypted unique identifier of the electronic device, and where the encrypted unique identifier indicates that the electronic device is an instance of an authorized access point in the WLAN.

Note that the packet may be a management packet. For example, the encrypted unique identifier may be included in a manufacturer-specific information element in the management packet.

Moreover, the unique identifier may be one of: a media access control (MAC) address of the electronic device, a Serial Number of the electronic device, an AID of the electronic device, channel information of the electronic device, or a radio-frequency configuration of the electronic device. In some embodiments, the electronic device may be an instance of an authorized access point when the unique identifier is associated with a manufacturer of the electronic device.

Furthermore, the encryption key or the secure hash function may be common to or shared by the electronic device and the second electronic device.

Additionally, prior to providing the packet, the electronic device may have received: the encryption key, the secure hashing function, the unique identifier of the electronic device, and/or a unique identifier of the second electronic device from a controller.

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating a system in accordance with an embodiment of the present disclosure.

FIG. 2 is a flow diagram illustrating a method for detecting a rogue access point in a WLAN in the system in FIG. 1 in accordance with an embodiment of the present disclosure.

FIG. 3 is a flow diagram illustrating a method for providing a unique identifier in a WLAN in the system in FIG. 1 in accordance with an embodiment of the present disclosure.

FIG. 4 is a drawing illustrating an example of communication among electronic devices in FIG. 1 in accordance with an embodiment of the present disclosure.

FIG. 5 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device (such as an access point) may receive a packet (or a frame, which is included in a packet) from a second electronic device, where the packet includes an encrypted unique identifier of the second electronic device. For example, the encrypted unique identifier may be included in a manufacturer-specific information element in a management packet. Then, the electronic device may decrypt the encrypted unique identifier using an encryption key or a secure hash function to obtain the unique identifier. Next, the electronic device may determine whether the second electronic device is an instance of an authorized access point in the WLAN based at least in part on the unique identifier. Note that the unique identifier may be one of: a MAC address of the second electronic device, a Serial Number of the second electronic device, an AID of the second electronic device, channel information of the second electronic device, or a radio-frequency configuration of the second electronic device. In some embodiments, the second electronic device may be an instance of an authorized access point when the unique identifier is associated with a manufacturer of the electronic device and/or the second electronic device.

By determining whether the second electronic device is an instance of an authorized access point, these communication techniques may be used to identify rogue access points in the WLAN. Moreover, once a rogue (or otherwise unauthorized) access point is identified, the electronic device may take appropriate remedial action to eliminate a security risk posed by the rogue access point and/or to remove the roque access point from the WLAN. Consequently, the communication techniques may improve security in and communication performance of the WLAN, and thus may improve the user experience and customer satisfaction when communicating using the WLAN and/or using the electronic device.

In a second group of embodiments, an electronic device (such as an access point) may encrypt a unique identifier of the electronic device using an encryption key or a secure hash function to obtain an encrypted unique identifier. Then, the electronic device may provide a packet (or a frame, which is included in a packet) to the second electronic device, where the packet includes the encrypted unique identifier of the electronic device, and where the encrypted unique identifier indicates that the electronic device is an instance of an authorized access point in the WLAN. For example, the encrypted unique identifier may be included in a manufacturer-specific information element in the management packet. Note that the unique identifier may be one of: a MAC address of the electronic device, a Serial Number of the electronic device, an AID of the electronic device, channel information of the electronic device, or a radio-frequency configuration of the electronic device. In some embodiments, the electronic device may be an instance of an authorized access point when the unique identifier is associated with a manufacturer of the electronic device.

By providing the encrypted unique identifier, these communication techniques may be used to confirm that the electronic device is an instance of an authorized access point. Therefore, the communication techniques may be used to identify a rogue (or unauthorized) access point in the WLAN. Moreover, once identified, appropriate remedial action may be taken to eliminate a security risk posed by a rogue access point and/or to remove the roque access point from the WLAN. Consequently, the communication techniques may improve security in and communication performance of the WLAN, and thus may improve the user experience and customer satisfaction when communicating using the WLAN and/or using the electronic device.

In the discussion that follows, electronic devices or components in a system communicate packets in accordance with a wireless communication protocol, such as: a wireless communication protocol that is compatible with an IEEE 802.11 standard (which is sometimes referred to as WiFi®, from the Wi-Fi Alliance of Austin, Tex.), Bluetooth® (from the Bluetooth Special Interest Group of Kirkland, Wash.), and/or another type of wireless interface (such as another wireless-local-area-network interface). Moreover, an access point in the system may communicate with a controller or services using a wired communication protocol, such as a wired communication protocol that is compatible with an Institute of Electrical and Electronics Engineers (IEEE) 802.3 standard (which is sometimes referred to as ‘Ethernet’), e.g., an Ethernet II standard. However, a wide variety of communication protocols may be used in the system, including wired and/or wireless communication. In the discussion that follows, Ethernet and Wi-Fi are used as illustrative examples.

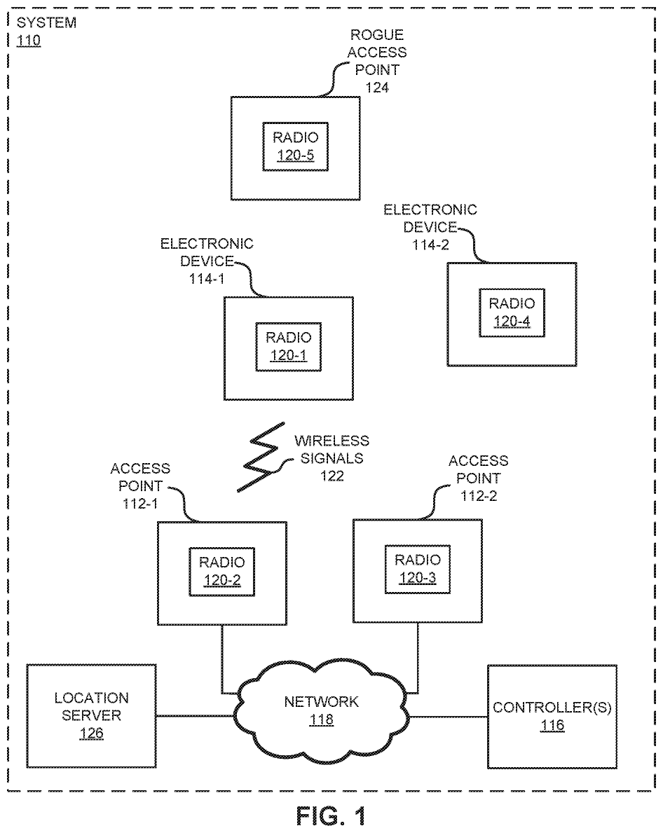

We now describe some embodiments of the communication techniques. FIG. 1 presents a block diagram illustrating an example of a system 110, which may include components, such as: one or more access points 112, one or more electronic devices 114 (such as cellular telephones, stations, another type of electronic device, etc.), and one or more optional controllers 116. In system 110, the one or more access points 112 may wirelessly communicate with the one or more electronic devices 114 using wireless communication that is compatible with an IEEE 802.11 standard. Thus, the wireless communication may occur in a 2.4 GHz, a 5 GHz and/or a 60 GHz frequency band. (Note that IEEE 802.11ad communication over a 60 GHz frequency band is sometimes referred to as ‘WiGig.’ In the present discussion, these embodiments also encompassed by ‘Wi-Fi.’) However, a wide variety of frequency bands may be used. Moreover, the one or more access points 112 may communicate with the one or more optional controllers 116 via network 118 (such as the Internet, an intra-net and/or one or more dedicated links). Note that the one or more optional controllers 116 may be at the same location as the other components in system 110 or may be located remotely (i.e., at a different location). Moreover, note that the one or more access points 112 may be managed by the one or more optional controllers 116. Furthermore, note that the one or more access points 112 may provide access to network 118 (e.g., via an Ethernet protocol), and may be a physical access point or a virtual or ‘software’ access point that is implemented on a computer or an electronic device. While not shown in FIG. 1, there may be additional components or electronic devices, such as a switch or a router.

Additionally, as noted previously, the one or more access points 112 and the one or more electronic devices 114 may communicate via wireless communication. In particular, one or more of access points 112 and one or more of electronic devices 114 may wirelessly communicate while: transmitting advertising frames on wireless channels, detecting one another by scanning wireless channels, exchanging subsequent data/management packets (such as association requests and responses) to establish a connection, configure security options (e.g., Internet Protocol Security), transmit and receive frames or packets via the connection (which may include the association requests and/or additional information as payloads), etc. Note that a frame may be included in (and, thus, may be a subset of) a packet.

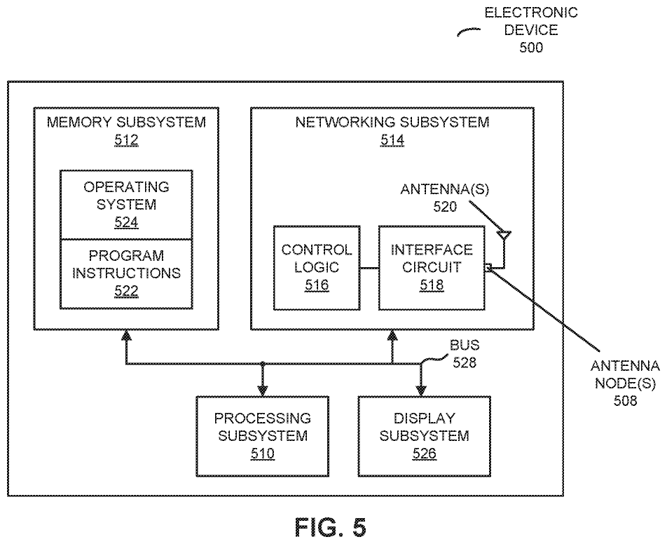

As described further below with reference to FIG. 5, the one or more access points 112, the one or more electronic devices 114 and/or the one or more optional controllers 116 may include subsystems, such as a networking subsystem, a memory subsystem and a processor subsystem. In addition, the one or more access points 112 and the one or more electronic devices 114 may include radios 120 in the networking subsystems. More generally, the one or more access points 112 and the one or more electronic devices 114 can include (or can be included within) any electronic devices with the networking subsystems that enable the one or more access points 112 and the one or more electronic devices 114 to wirelessly communicate with each other.

As can be seen in FIG. 1, wireless signals 122 (represented by a jagged line) are transmitted from a radio 120-1 in electronic device 114-1. These wireless signals are received by radio 120-2 in at least one of the one or more access points 112, such as access point 112-1. In particular, electronic device 114-1 may transmit frames or packets. In turn, these frames or packets may be received by access point 112-1. This may allow electronic device 114-1 to communicate information to access point 112-1. Note that the communication between electronic device 114-1 and access point 112-1 may be characterized by a variety of performance metrics, such as: a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 120 are shown in the one or more electronic devices 114 and the one or more access points 112, one or more of these instances may be different from the other instances of radios 120.

As noted previously, system 110 may include a rogue access point 124. The presence of rogue access point 124 may adversely impact security and/or the communication performance in system 110. Note that a ‘rogue access point’ may operate in system 110 without permission or knowledge of a network administrator of system 110. Therefore, rogue access point 124 may be unauthorized.

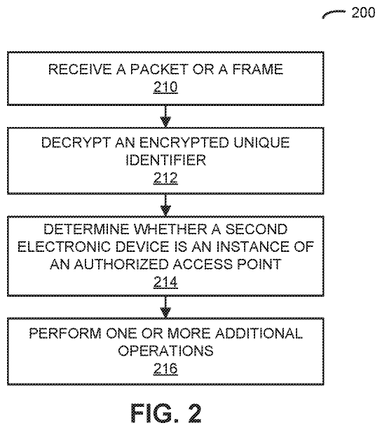

In order to address this challenge, the one or more access points 112 (such as access point 112-1) may implement or use the communication techniques. Notably, as discussed further below with reference to FIGS. 2-4, during the communication techniques access point 112-1 may receive one or more packets or frames from one of the optional controllers 116. The one or more packets or frames may include: an encryption key (such as a symmetric encryption key), a secure hash function (such as SHA-256), a unique identifier (which is sometimes referred to as a ‘signature’ or a ‘fingerprint’) of access point 112-1, and/or a unique identifier of access point 112-2. Note that the one of the optional controllers 116 may provide similar information to access point 112-2. For example, access point 112-2 may receive one or more additional packets or frames with: the encryption key, the secure hashing function, a unique identifier of access point 112-2, and/or a unique identifier of access point 112-1. Thus, at a given time, the encryption key and/or the secure hash function may be common to or shared by access points 112.

Subsequently, access point 112-2 may optionally encrypt a unique identifier of access point 112-2 using the encryption key or the secure hash function to obtain an encrypted unique identifier. (Alternatively, in some embodiments, access point 112-2 may receive the encrypted unique identifier from the one of the optional controllers 116.) Then, access point 112-2 may provide, using radio 120-3, a packet (or a frame) to one of electronic devices 114 (such as electronic device 114-1). Thus, the packet may be addressed to electronic device 114-1. Moreover, the packet may include the encrypted unique identifier of access point 112-2, and the encrypted unique identifier may indicate that access point 112-2 is an instance of an authorized access point in a WLAN.

Note that the packet may be a management packet. For example, the encrypted unique identifier may be included in a manufacturer-specific information element in the management packet. Moreover, the unique identifier may be one of: a MAC address of access point 112-2, a Serial Number of access point 112-2, an AID of access point 112-2, channel information of access point 112-2, and/or a radio-frequency configuration of access point 112-2. In some embodiments, access point 112-2 may be an instance of an authorized access point when the unique identifier is associated with a manufacturer of access points 112.

Radio 120-2 in access point 112-1 may also receive the packet that was provided by access point 112-2 to electronic device 114-1. Using the encryption key or the secure hashing function, access point 112-1 may decrypt the encrypted unique identifier in the packet to obtain the unique identifier. Next, access point 112-1 may determine whether access point 112-2 is an instance of an authorized access point in the WLAN based at least in part on the unique identifier. For example, access point 112-1 may compare the unique identifier to stored information in access point 112-1 (such as information previously received from the one of the optional controllers 116). Alternatively, in some embodiments, access point 112-1 may provide the unique identifier to the one of the optional controllers 116 to determine whether access point 112-2 is an instance of an authorized access point in the WLAN. In this case, access point 112-1 may determine that access point 112-2 is an instance of an authorized access point.

However, when rogue access point 124 attempts to communicate in the WLAN, it may not be able to correctly duplicate the unique identifier of one of access points 112. Notably, while rogue access point 124 may be able to intercept wireless communication in the WLAN, and may attempt to copy information from one of access points 112, in an attempt at spoofing or a man-in-the-middle attack, rogue access point 124 will not have the encryption key, the secure hash function or an authorized or approved unique identifier. Therefore, access points 112 in the WLAN may be able to detect that rogue access point 124 is a rogue access point, so that appropriate remedial action can be taken.

For example, rogue access point 124 may provide a second packet (or a frame) to one of electronic devices 114 (such as electronic device 114-1). Rogue access point 124 may include an incorrect unique identifier (or digital information) in the second packet. Radio 120-2 in access point 112-1 may receive the second packet that was provided by rogue access point 124. Using the encryption key or the secure hashing function, access point 112-1 may decrypt the incorrect identifier in the second packet in an attempt to obtain a second unique identifier (presumably of rogue access point 124, if rogue access point 124 is an instance of an authorized access point). Next, access point 112-1 may determine whether rogue access point 124 is an instance of an authorized access point in the WLAN based at least in part on the second unique identifier. For example, access point 112-1 may compare the second unique identifier to stored information in access point 112-1 (such as information previously received from the one of the optional controllers 116). Alternatively, in some embodiments, access point 112-1 may provide the second unique identifier to the one of the optional controllers 116 to determine whether rogue access point 124 is an instance of an authorized access point in the WLAN. In this case, access point 112-1 may determine that rogue access point 124 is not an instance of an authorized access point (i.e., that rogue access point 124 is unauthorized).

In response, access point 112-1 may perform a remedial action. For example, access point 112-1 may provide a message (such as an alert) to optional controllers 116 and/or to one or more additional access points in the WLAN (such as access point 112-2). Moreover, access point 112-1 may: provide a second message (such as a warning) to electronic device 114-1 that is associated with rogue access point 124, prevent electronic device 114-1 from associating with rogue access point 124, or de-authenticate electronic device 114-1 from the WLAN, so that the association between electronic device 114-1 and rogue access point 124 is discontinued. Furthermore, access point 112-1 may change a channel used by access point 112-1 in the WLAN and/or an SSID of access point 112-1.

In some embodiments, additional information may be used to determine whether a given access point is an instance of an authorized access point in the WLAN. For example, two or more of access points 112 may determine a location of the given access point, such as rogue access point 124. Then, when determining whether a given access point is an instance of an authorized access point, access point 112-1 may compare the determined location to known or predetermined locations of access points 112. Alternatively or additionally, in some embodiments, access point 112-1 may provide information that specifies the determined location of rogue access point 124 to location server 126 (or one of the optional controllers 116) to determine whether rogue access point 124 is at a known or predetermined location of one of access points 112. This location information may then be used by access point 112-1 when determining whether rogue access point 124 is an instance of an authorized access point.

In this way, the communication techniques may determine that rogue access point 124 is not authorized in the WLAN. This may allow appropriate remedial action to be taken, such as excluding rogue access point 124 from system 110. Thus, communication techniques may improve the security and/or the communication performance in system 110.

In the described embodiments, processing a frame or a packet in the electronic devices and/or the one or more access points may include: receiving wireless signals 122 with the frame or packet; decoding/extracting the frame or packet from the received wireless signals 122 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 112, the one or more electronic devices 114, the one or more optional controllers 116 and/or rogue access point 124. As another example, in another embodiment, different electronic devices are transmitting and/or receiving frames or packets.

We now describe embodiments of the method. FIG. 2 presents a flow diagram illustrating an example of a method 200 for detecting a rogue access point in a WLAN. Moreover, method 200 may be performed by an electronic device, such as one of the one or more access points 112 in FIG. 1, e.g., access point 112-1. During operation, the electronic device may receive a packet (or a frame) (operation 210) from the second electronic device, where the packet includes an encrypted unique identifier of the second electronic device. Note that the packet may be a management packet. For example, the encrypted unique identifier may be included in a manufacturer-specific information element in the management packet.

Then, the electronic device may decrypt the encrypted unique identifier (operation 212) using an encryption key or a secure hash function to obtain the unique identifier. Moreover, the unique identifier may be one of: a MAC address of the second electronic device, a Serial Number of the second electronic device, an AID of the second electronic device, channel information of the second electronic device, or a radio-frequency configuration of the second electronic device. Note that the encryption key or the secure hash function may be common to or shared by the electronic device and the second electronic device if the second electronic device is an instance of an authorized access point.

Next, the electronic device may determine whether the second electronic device is an instance of an authorized access point (operation 214) in the WLAN based at least in part on the unique identifier. In some embodiments, the second electronic device may be an instance of an authorized access point when the unique identifier is associated with a manufacturer of the electronic device and/or the second electronic device.

In some embodiments, the electronic device optionally performs one or more additional operations (operation 216). For example, prior to receiving the packet (operation 210), the electronic device may have received: the encryption key, the secure hashing function, a unique identifier of the second electronic device, and/or the unique identifier of the electronic device from a controller.

In some embodiments, when the second electronic device is not the instance of the authorized access point (operation 214), the electronic device performs a remedial action. For example, the electronic device may provide a message (such as an alert) to the controller and/or to one or more additional access points in the WLAN. Moreover, the electronic device may provide a second message (such as a warning) to a third electronic device that is associated with the second electronic device, or may de-authenticate the third electronic device from the WLAN, so that the association between the third electronic device and the second electronic device is discontinued. Furthermore, the electronic device may change a channel used by the electronic device in the WLAN and/or a SSID of the electronic device. Additionally, the electronic device may prevent a third electronic device from associating with the second electronic device.

Alternatively, when the second electronic device is an instance of an authorized access point (operation 214), the electronic device may take no further action.

Moreover, the electronic device may determine a location of the second electronic device (e.g., using triangulation or trilateration), and may determine whether the second electronic device is the instance of an authorized access point (operation 214) based at least in part on the location. Note that the location may be determined in conjunction with other access points in the WLAN.

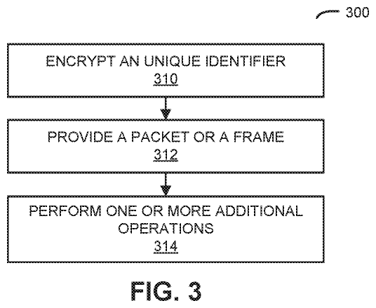

FIG. 3 presents a flow diagram illustrating an example of a method 300 for providing a unique identifier. Method 300 may be performed by an electronic device, such as one of the one or more access points 112 in FIG. 1, e.g., access point 112-1. During operation, the electronic device may encrypt a unique identifier (operation 310) of the electronic device using an encryption key or a secure hash function to obtain an encrypted unique identifier. Then, the electronic device may provide a packet (or a frame) (operation 312) to the second electronic device, where the packet includes the encrypted unique identifier of the electronic device, and where the encrypted unique identifier indicates that the electronic device is an instance of an authorized access point in the WLAN.

Note that the packet may be a management packet. For example, the encrypted unique identifier may be included in a manufacturer-specific information element in the management packet.

Moreover, the unique identifier may be one of: a MAC address of the electronic device, a Serial Number of the electronic device, an AID of the electronic device, channel information of the electronic device, or a radio-frequency configuration of the electronic device. In some embodiments, the electronic device may be an instance of an authorized access point when the unique identifier is associated with a manufacturer of the electronic device.

Furthermore, the encryption key or the secure hash function may be common to or shared by the electronic device and the second electronic device.

In some embodiments, the electronic device optionally performs one or more additional operations (operation 314). For example, prior to providing the packet (operation 312), the electronic device may have received: the encryption key, the secure hashing function, the unique identifier of the electronic device, and/or a unique identifier of the second electronic device from a controller.

In some embodiments of methods 200 and/or 300, there may be additional or fewer operations. Moreover, the order of the operations may be changed, and/or two or more operations may be combined into a single operation. For example, instead of encrypting the unique identifier (operation 310), in some embodiments the unique identifier may be pre-encrypted (i.e., the encrypted unique identifier may be predetermined or pre-generated).

Furthermore, in some embodiments, the unique identifiers, the encryption key or the secure hash function may be dynamically changed. For example, the electronic device and the second electronic device may have a look-up table with different unique identifiers, encryption keys and/or secure hashing functions that are used at different times or different time intervals. Alternatively, the controller may periodically distribute new unique identifiers, encryption keys and/or secure hash functions in the WLAN.

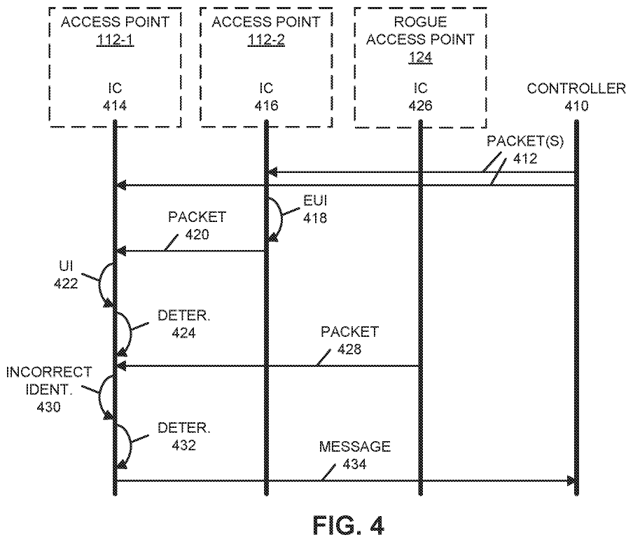

Embodiments of the communication techniques are further illustrated in FIG. 4, which presents a drawing illustrating an example of communication between access point 112-1, access point 112-2, rogue access point 124 and controller 410 according to some embodiments. Notably, controller 410 may provide one or more packets 412 to access points 112-1 and 112-2. Note that the one or more packets 412 may include: an encryption key, a secure hashing function, a unique identifier of access point 112-1, and/or a unique identifier of access point 112-2. Moreover, an interface circuit 414 in access point 112-1 and an interface circuit 416 in access point 112-2 may receive the one or more packets 412.

Subsequently, interface circuit 416 may encrypt a unique identifier of access point 112-2 using the encryption key or the secure hash function to obtain an encrypted unique identifier (EUI) 418. Then, interface circuit 416 may provide a packet 420 that includes the encrypted unique identifier 418 of access point 112-2.

Interface circuit 414 may receive packet 420, and may, using the encryption key or the secure hashing function, decrypt the encrypted unique identifier in packet 420 to obtain unique identifier (UI) 422. Next, interface circuit 414 may determine 424 that access point 112-2 is an instance of an authorized access point in the WLAN based at least in part on the unique identifier 422.

Alternatively, interface circuit 426 in rogue access point 124 may provide a packet 428 with an incorrect identifier 430. Interface circuit 414 may receive packet 428, and may, using the encryption key or the secure hashing function, decrypt the incorrect identifier in packet 428 to obtain incorrect identifier 430. Next, interface circuit 414 may determine 432 that rogue access point 124 is not an instance of an authorized access point in the WLAN based at least in part on the incorrect identifier 428. In response, interface circuit 414 may perform a remedial action. For example, interface circuit 414 may provide a message 434 (such as an alert) to controller 410.

While FIG. 4 illustrates communication between components using unidirectional or bidirectional communication with lines having single arrows or double arrows, in general the communication in a given operation in this figure may involve unidirectional or bidirectional communication.

In some embodiments, the communication techniques may provide an effective and efficient approach to prevent a man-in-the-middle attack. Notably, an access point may be able to recognize and prevent a malicious or rogue access point that is trying to send beacons and probe responses to a station in a WLAN to mislead the station into associating or connecting with the rogue access point. By adding an extra layer of proprietary protection, the access point may prevent a man-in-the-middle attack.

For example, an access point may be able to detect SSID-spoofing, MAC-spoofing and/or LAN-spoofing. However, existing access points may be unable to identify and prevent a man-in-the-middle attack. For example, using the key reinstallation attack (KRACK) vulnerability, a rogue access point may be able to hijack electronic devices in a WLAN. Notably, a rogue access point may hop between two channels, and may broadcast a replay of a beacon of an access point in another (different) channel. A station may scan the other channel and may add the rogue access point to a scan table. This may lead the station to associate (incorrectly) with the rogue access point. In this scenario, the legitimate access point may be unable to detect the rogue access point, because the rogue access point uses a replay and relay trick to avoid detection by existing rogue detection techniques.

This problem may be addressed using the communication techniques. Notably, by using the encrypted unique identifier, even if the rogue access point is able to hijack the management packet from the access point to apply the replay and relay trick, it is unable to decode the encrypted unique identifier. Thus, the rogue access point is unable to include an encrypted version of its unique identifier in the management packet, so it is unable to fool the legitimate access points in the WLAN. Consequently, the legitimate access points in the WLAN may be able to detect and report the presence and proximity of the rogue access point and the attempted man-in-the-middle attack.

Once the rogue access point is detected, the legitimate access point may classify it as malicious and report it to controller to alert users of the WLAN. The users may enable a defense mode to proactively de-authenticate the rogue access point to prevent stations from connecting to the rogue access point. This may improve the security of the WLAN for man-in-the-middle attacks and may prevent electronic devices from being hijacked by the rogue access point.

Moreover, the communication techniques may provide real-time detection and alerts. Notably, the communication techniques may detect the rogue access point before a station tries to authenticate or associate with the rogue access point. Furthermore, the communication techniques may provide an additional layer of security to a wireless intrusion protection system.

Thus, the communication techniques may offer enhanced protection without increasing complexity or extra expense. For example, the communication techniques may be implemented in software (and, therefore, in some embodiments may not require a hardware modification or change).

We now describe embodiments of an electronic device, which may perform at least some of the operations in the communication techniques. For example, the electronic device may include a component in system 110, such as one of: the one or more access points 112, the one or more electronic devices 114 and/or the one or more optional controllers 116. FIG. 5 presents a block diagram illustrating an electronic device 500 in accordance with some embodiments. This electronic device includes processing subsystem 510, memory subsystem 512, and networking subsystem 514. Processing subsystem 510 includes one or more devices configured to perform computational operations. For example, processing subsystem 510 can include one or more microprocessors, ASICs, microcontrollers, programmable-logic devices, graphical processor units (GPUs) and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory (which collectively or individually are sometimes referred to as a ‘computer-readable storage medium’). In some embodiments, instructions for processing subsystem 510 in memory subsystem 512 include: one or more program modules or sets of instructions (such as program instructions 522 or operating system 524), which may be executed by processing subsystem 510. Note that the one or more computer programs may constitute a computer-program mechanism. Moreover, program instructions in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as nodes 508, e.g., a pad, which can be coupled to the one or more antennas 520. Thus, electronic device 500 may or may not include the one or more antennas 520.) For example, networking subsystem 514 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 500 may be adapted or changed using pattern shapers (such as reflectors) in one or more antennas 520 (or antenna elements), which can be independently and selectively electrically coupled to ground to steer the transmit antenna radiation pattern in different directions. Thus, if one or more antennas 520 includes N antenna-radiation-pattern shapers, the one or more antennas 520 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 4 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting packets or frames and/or scanning for packets or frames transmitted by other electronic devices.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a subnotebook/netbook, a server, a computer, a mainframe computer, a cloud-based computer, a tablet computer, a smartphone, a cellular telephone, a smartwatch, a consumer-electronic device, a portable computing device, an access point, a transceiver, a controller, a radio node, a router, a switch, communication equipment, an access point, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments program instructions 522 is included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 514. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively or additionally, at least some of the operations in the communication techniques may be implemented in a physical layer, such as hardware in interface circuit 518.

Moreover, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 60 GHz, and/or a band of frequencies used by a Citizens Broadband Radio Service or by LTE. In some embodiments, the communication between electronic devices uses multi-user transmission (such as orthogonal frequency division multiple access or OFDMA).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to wirelessly communicate with a second electronic device, wherein the electronic device is configured to:
receive, at the interface circuit, a packet or frame associated with the second electronic device, wherein the packet or frame comprises an encrypted unique identifier of the second electronic device;
decrypt the encrypted unique identifier using an encryption key or a secure hash function to obtain a unique identifier; and
determine whether the second electronic device is an instance of an authorized access point in a wireless local area network (WLAN) based at least in part on the unique identifier.

2. The electronic device of claim 1, wherein the electronic device comprises an access point.

3. The electronic device of claim 1, wherein the packet or frame comprises a management packet or frame.

4. The electronic device of claim 3, wherein the encrypted unique identifier is included in a manufacturer-specific information element in the management packet or frame.

5. The electronic device of claim 1, wherein the unique identifier comprises one of: a media access control (MAC) address of the second electronic device, a Serial Number of the second electronic device, an association identifier (AID) of the second electronic device, channel information of the second electronic device, or a radio-frequency configuration of the second electronic device.

6. The electronic device of claim 1, wherein the second electronic device is an instance of an authorized access point when the unique identifier is associated with a manufacturer of the electronic device.

7. The electronic device of claim 1, wherein the encryption key or the secure hash function are shared by the electronic device and the second electronic device.

8. The electronic device of claim 1, wherein, prior to receiving the packet or frame, the electronic device is configured to receive, at the interface circuit and associated with a controller, one or more of: the encryption key, the secure hashing function, the unique identifier of the second electronic device, or a unique identifier of the electronic device.

9. The electronic device of claim 1, wherein, when the second electronic device is not the instance of the authorized access point, the electronic device is configured to perform a remedial action.

10. The electronic device of claim 9, wherein the remedial action comprises one or more of: providing a message addressed to a controller; providing a second message addressed to one or more additional access points in the WLAN; providing a third message addressed to a third electronic device that is associated with the second electronic device; de-authenticating the third electronic device from the WLAN, so that an association between the third electronic device and the second electronic device is discontinued; changing a channel used by the electronic device in the WLAN; changing a service set identifier (SSID) of the electronic device; or preventing the third electronic device from associating with the second electronic device.

11. The electronic device of claim 1, wherein the electronic device is configured to determine a location of the second electronic device; and
wherein determining whether the second electronic device is the instance of an authorized access point is based at least in part on the location.

12. A non-transitory computer-readable storage medium for use in conjunction with an electronic device, the computer-readable storage medium storing program instructions that, when executed by the electronic device, cause the electronic device to perform operations, comprising:
receiving, at an interface circuit in the electronic device, a packet or frame associated with a second electronic device, wherein the packet or frame comprises an encrypted unique identifier of the second electronic device;
decrypting the encrypted unique identifier using an encryption key or a secure hash function to obtain a unique identifier; and
determining whether the second electronic device is an instance of an authorized access point in a wireless local area network (WLAN) based at least in part on the unique identifier.

13. The non-transitory computer-readable storage medium of claim 12, wherein the electronic device comprises an access point.

14. The non-transitory computer-readable storage medium of claim 12, wherein the packet or frame comprises a management packet or frame.

15. The non-transitory computer-readable storage medium of claim 14, wherein the encrypted unique identifier is included in a manufacturer-specific information element in the management packet or frame.

16. The non-transitory computer-readable storage medium of claim 12, wherein the second electronic device is an instance of an authorized access point when the unique identifier is associated with a manufacturer of the electronic device.

17. The non-transitory computer-readable storage medium of claim 12, wherein the encryption key or the secure hash function are shared by the electronic device and the second electronic device.

18. The non-transitory computer-readable storage medium of claim 12, wherein, prior to receiving the packet or frame, the operations comprise receiving, at the interface circuit and associated with a controller, one or more of: the encryption key, the secure hashing function, the unique identifier of the second electronic device, or a unique identifier of the electronic device.

19. The non-transitory computer-readable storage medium of claim 12, wherein, when the second electronic device is not the instance of the authorized access point, the operations comprise performing a remedial action.

20. A method for detecting a rogue access point, comprising:
by an electronic device:
receiving, at an interface circuit in the electronic device, a packet or frame associated with a second electronic device, wherein the packet or frame comprises an encrypted unique identifier of the second electronic device;
decrypting the encrypted unique identifier using an encryption key or a secure hash function to obtain a unique identifier; and
determining whether the second electronic device is an instance of an authorized access point in a wireless local area network (WLAN) based at least in part on the unique identifier.
